(19) United States
(12) Patent Application Publication
(10) Pub. No.: US 2008/0168014 A1
(43) Pub. Date: Jul. 10, 2008

(54) Catalyst discovery through pattern recognition-based modeling and data analysis

(76) Inventors: Phiroz M. Bhagat, Westfield, NJ (US); Kirk D. Schmitt, Pennington, NJ (US)

Correspondence Address: ExxonMobil Research and Engineering Company, P.O. Box 900, Annandale, NJ, 08801-0900, US

(21) Appl. No.: 12/001,906

(22) Filed: Dec. 13, 2007

Related U.S. Application Data
(60) Provisional application No. 60/877,269, filed on Dec. 27, 2006.

(51) Int. Cl. G06F 15/18

(52) U.S. Cl. 706/20

(57) ABSTRACT

The present invention is a method to determine catalyst structures by correlating experimental conditions and directing agent characteristics to catalyst products. The correlating step is carried out by a performance model such as a neural net.

This Application claims the benefit of U.S. Provisional Application 60/877,269 filed Dec. 27, 2006.

### BACKGROUND OF THE INVENTION

The present invention relates to catalyst discovery, especially zeolite catalyst discovery. In particular, the invention achieves this by pattern recognition-based modeling and data analysis.

Aluminosilicate and silicoaluminophosphate zeolites are among the most important catalysts used by the petroleum industry. The discovery of new zeolites has been actively pursued for fifty years, but fewer than 100 new zeolites have been discovered. In that same time, millions of new organic and organometallic compounds and tens of thousands of new inorganic compounds have been discovered so it is instructive to ask “why so few zeolites?” The answer lies in our lack of understanding of how to construct these three-dimensional crystalline networks via the “molecule driven” methods so useful in organic chemistry and petroleum processing.

Zeolites cannot be synthesized by sequential addition of fragments or systematic rearrangement of already existing materials, but spring completely formed by nucleation of unknown substructures within complex gels. All we can do to promote the synthesis of a particular zeolite is to provide conditions conducive to the growth of that structure. Known variables include temperature, time, pH, heat-up method (aging, ramping, multiple soak times), agitation (static, stirring, tumbling, shear rate, impeller type), sources of Si, Al, P and minor atoms, mineralizing agent (hydroxide or fluoride), inorganic structure directing cations (Li, Na, K), reagent ratios, solvent, order of addition of reagents, and organic structure directing agents (amines, quaternary ammonium and phosphonium compounds, metal complexes, amino acids). Of these, about half of all new zeolites have been discovered by variation of the first twelve parameters and the rest by variation of the thirteenth, the organic directing agent.

At present, there appears to be no theoretical basis for predicting conditions to promote new, hypothetical zeolites and it is clear that the number of parameters available could well overwhelm any conceivable high throughput experimentation technique. Nevertheless, it would be useful to derive guidelines that enable intelligent searching of the experimental space in order to increase the probability of discovering new materials.

### SUMMARY OF THE INVENTION

The present invention is a method to determine catalyst structures by correlating experimental conditions and directing agent characteristics to catalyst products. The invention includes (1) characterizing the directing agents and the resulting catalyst structures obtained through synthesizing experiments; and (2) the modeling architecture that correlates the experimental conditions and directing agents with the resulting catalyst structure.

The invention enhances the catalyst discovery process by integrating contemporary experimental methods (such as High Throughput) with pattern recognition-based modeling and data analysis to identify promising directing agents and experimental conditions as follows:
Quantitatively characterizing directing agents and catalyst structures so as to permit generalized representation in models
Classifying catalyst producing experimental data into self-organized clusters sharing similar characteristics
Modeling experimental data (by using neural nets) to correlate directing agents and experimental conditions with resulting catalyst material
Coupling Genetic Algorithms to the adaptive learning models to search the experimental space for identifying potentially high yielding results
Iterating between conducting experiments and updating adaptive learning models to enhance catalyst discovery

The advantage that the present invention affords over the prior art is that important experimental conditions are rapidly identified expediting the catalyst discovery process.

### BRIEF DESCRIPTION OF THE DRAWINGS

FIG. 1 shows a schematic diagram of the correspondence between the experimental conditions and the directing agent characteristics with the resulting catalyst structures.

FIG. 2 shows a schematic diagram of the correspondence between the experimental conditions and pore sizes of the catalyst structures using a two-stage model.

FIG. 3 shows a schematic diagram wherein the data are self-organized into clusters sharing similar characteristics.

FIG. 4 shows a schematic diagram of the self-organizing neural net architecture used in the present invention.

FIG. 5 shows a schematic diagram of one of the architectures, the back-propagation neural net, used in the present invention.

FIG. 6 shows a schematic diagram of the first modeling stage which yields a digital outcome wherein the inputs are correlated with binary results for the formation of pores in any of three directions.

FIG. 7 shows a schematic diagram of the second modeling stage wherein any of the three positive binary outcomes from the first modeling stage is quantified.

FIG. 8 shows a parity plot of the results of the second modeling stage for the size of axis 1 in pore direction 1.

FIG. 9 shows a parity plot of the results of the second modeling stage for the size of axis 2 in pore direction 1.

FIG. 10 shows a parity plot of the results of the second modeling stage for the size of axis 1 in pore direction 2.

FIG. 11 is an expanded figure of the relevant region of FIG. 10.

FIG. 12 shows a parity plot of the results of the second modeling stage for the size of axis 2 in pore direction 2.

FIG. 13 is an expanded figure of the relevant region of FIG. 12.

FIG. 14 shows a parity plot of the results of the second modeling stage for the size of axis 1 in pore direction 3.

FIG. 15 is an expanded figure of the relevant region of FIG. 14.

FIG. 16 shows a parity plot of the results of the second modeling stage for the size of axis 2 in pore direction 3.

FIG. 17 is an expanded figure of the relevant region of FIG. 16.

FIG. 18 shows a schematic diagram of coupling a genetic algorithm with a performance model.

FIG. 19 shows a schematic diagram iterating genetic algorithm results with experimental validation.

### DETAILED DESCRIPTION OF THE PREFERRED EMBODIMENTS

The present invention is a method to determine catalyst structures, in particular, zeolite structures. The method uses a correlative model that correlates experimental conditions and directing agent characteristics to catalyst products. In a preferred embodiment, the catalyst products are zeolites and the correlative model is a neural net.

### I. Examination of Data

### A. Data

Experimental zeolite crystallization data are obtained in conventional, stirred autoclaves with the times, temperatures, and mol ratios of reagents varied as described below. The products of the reactions are examined using powder X-ray diffraction and their structures assigned by comparison to known materials. Once the structures are know the materials are classified as “amorphous,” “dense,” or zeolitic. The pore sizes of zeolitic materials are assigned according to the International Zeolite listings (5th editon of the “Atlas of Zeolite Framework Types” by Ch. Baerlocher, W. M. Meier and D. H. Olson).

A set of 2000-4000 experiments suffice to vary the conditions sufficiently to develop and test the model. Neural net software suitable for this modeling is available commercially for example, “NeuroIntelligence,” from Alyuda (www.alyuda.com) or may be obtained free as source code from www.philbrierley.com or www.sourceforge.net.

### B. Parameters Used to Describe Experimental Conditions

The following independent parameters were used as input to the model to characterize the synthesizing experimental environment and conditions:
Al/Si ratio
Zn/Si ratio
Mn/Si ratio
Co Si ratio
OH—/Si ratio
Li/Si ratio
Na/Si ratio
K/Si ratio
Reactor temperature
Time at temperature in reactor
Parameters characterizing the directing agents (as described below)

It is necessary to capture the characteristics of the directing agents such that they can be represented in a generalized, quantitative manner in models. The agents are characterized thus:
Three length measures denoting their size in 3-D
Charge
Charge offset
Carbon to nitrogen ratio
Amount used in experiment

Models were developed (as described in the following sections) to determine whether these inputs could be correlated with the products of the experiments, i.e., the synthesized catalysts. Just as in the case of the directing agents, the synthesized catalysts also need to be represented by generalized, quantitative characteristics, which are:
Whether or not pores are formed
Nature of pores: straight or sinusoidal
Major and minor axes of each set of pores (in up to 3 orthogonal directions)
   C. Self-Organizing Data into Clusters

Very large numbers of experiments to synthesize catalysts can be self-organized into groups or clusters (as described in Section IV-A) based on the similarities of their experimental conditions and the characteristics of the directing agents. This type of auto-clustering takes into account only the independent parameters that are related to the way the experiments are performed, regardless of the nature of the synthesized catalysts. The object of such an exercise is to see whether the resulting clusters are associated with correspondingly similar synthesis products. A preliminary exercise of this type of data self-organization did indeed result in clusters that grouped, to a large extent, experiments yielding similar resulting catalyst structures. This indicated the feasibility of applying pattern recognition technology to the catalyst discovery project, and so we proceeded with the next, more detailed, phase that involved constructing correlative models.

D. Correlating Agents and Experimental Conditions with Catalyst Product Outcomes

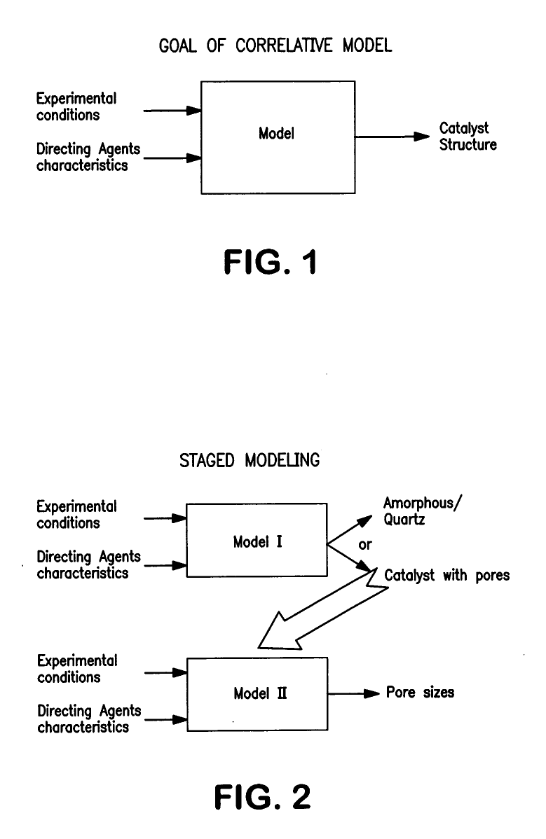

Encouraged that the self-organizing exercise showed a correspondence between the experimental conditions and the resulting catalyst structures, correlative neural nets (as described in Section IV-B) were trained on the data with the goal as illustrated in FIG. 1.

Such a modeling effort requires two tasks to be performed. The first would be to predict which experimental conditions would produce catalysts with pores as opposed to producing quartz or amorphous material. The second would be to correlate the quantitative features of the resulting catalyst structure (such as the size of the pores) with the experimental conditions. Rather than have a single model perform both these tasks, a two-stage modeling scheme was developed as shown in FIG. 2.

The first modeling stage yields a digital outcome in which the inputs are correlated with binary results for the formation (or not) of pores in any of three directions. Those data for which any one of the three binary outcomes is positive (indicating the formation of potential catalysts) are further processed in the second model which then quantifies the catalyst structure.

The preliminary results obtained from these models are very promising and are discussed in Section V.

### II. Underlying Technology

### A. Self-Organizing Methodology

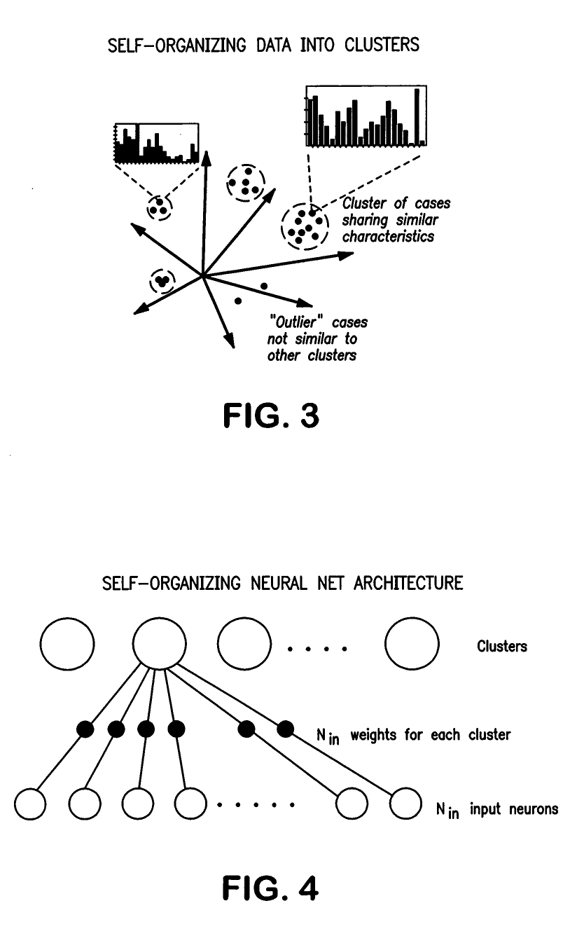

The data are self-organized into clusters sharing similar characteristics as shown in FIG. 3.

As discussed earlier, each datum point is quantified by a vector whose dimensionality corresponds to the total number of representative descriptions of the incident. For most events the dimensionality of this vector will be quite sparse. In other words, any given incident will very likely be described by just a small number of different conditions relative to the total number of possible descriptors.

A self-organizing neural net auto-classifies the data. The number of input neurons corresponds to the total number of descriptive dimensions, Nᵢₙ. Each neuron in the next layer corresponds to a cluster and have a number of weights equal to Nᵢₙ associated with it. FIG. 4 illustrates the architecture of such a neural net.

During the training process, the values of each element in an incident's vector are fed to the corresponding input neurons. The pattern presented by these Nᵢₙ vector element values are compared to the pattern of the Nᵢₙ weights for each cluster. The cluster whose weight pattern most closely resembles the vector's pattern “captures” that incident as one of its members provided that the similarity in the two patterns is within the specified tolerance (or selectivity level). If the closest pattern match is not within this tolerance, then the incident is assigned its own separate cluster, and the weights of that cluster are set to match the incident's pattern so as to be ready to capture another incident were its pattern to be similar. On the other hand, if an incident is “captured” by a cluster already containing other incidents, then the weights of this cluster adjust themselves to accommodate the new incident without losing the representative pattern of the previously captured incidents.

All the weights are initially randomized. Each training iteration consists of a cycle of presenting each of the incident vectors to the neural net following the procedure described above. With successive iterations the selectivity level is progressively tightened so that it asymptotically reaches the pre-specified value by the end of the training process. The result is a classification of all the incidents into clusters, and the identification of outlier incidents, i.e., those which did not “fit in” with the others.

### B. Neural Net Correlative Model

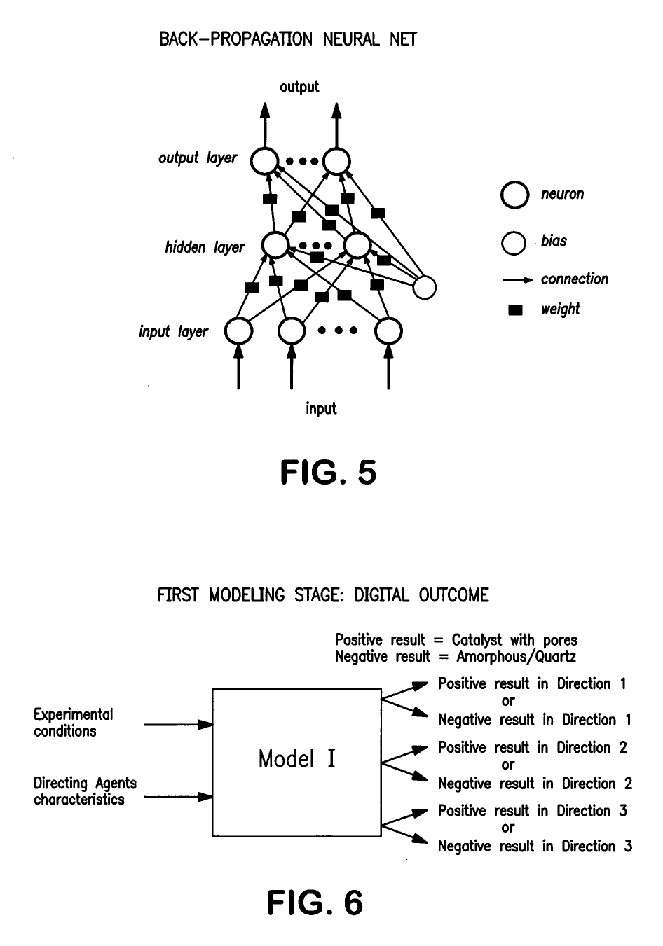

The back-propagation neural net (one of the many possible architectures) is used to construct the correlative model. This type of neural net is comprised of inter-connected simulated neurons (FIG. 5). A neuron is an entity capable of receiving and sending signals and is simulated by means of software algorithms on a computer. Each simulated neuron (i) receives signals from other neurons, (ii) sums these signals, (iii) transforms this sum, usually by means of a sigmoidal function (A sigmoidal function is a monotonic, continuously differentiable, bounded function: f(x)=1/(1+exp(−x)) and (iv) sends the result to yet other neurons. A weight, modifying the signal being communicated, is associated with each of the connections between neurons. The “information content” of the net is embodied in the set of all these weights, which, together with the net structure, constitute the model generated by the net.

This neural net has information flowing in the forward direction in the prediction mode and back-propagated error corrections in the learning mode. Such nets are usually organized into three layers of neurons. An input layer, as its name implies, receives input. An intermediate layer (also called the hidden layer as it is hidden from external exposure) lies between the input layer and the output layer, which communicates results externally. Additionally, a “bias” neuron, supplying an invariant output, is connected to each neuron in the hidden and output layers.

In the learning (or training) mode, the net is supplied with sets of data comprised of input values and corresponding target outcome values. The net then identifies and learns patterns correlating inputs to corresponding outcomes. Unrelated or random data will not result in any learning.

During the process of generating an outcome from given input data, signals flow only in the forward direction: from input to hidden to output layers. The given set of input values is imposed on the neurons in the input layer. These neurons transform the input signals and transmit the resulting values to neurons in the hidden layer. Each neuron in the hidden layer receives a signal (modified by the weight of the corresponding connection) from each neuron in the input layer. The neurons in the hidden layer individually sum up the signals they receive together with the weighted signal from the bias neuron, transform this sum and then transmit the result to each of the neurons in the next layer. Ultimately, the neurons in the output layer receive weighted signals from neurons in hidden layer, sum the signals, and emit the transformed sums as outputs from the net.

The weights for each connection are initially randomized. When the net undergoes training, the errors between the results of the output neurons and the desired corresponding target values are propagated backwards through the net. This backward propagation of error signals is used to update the connection weights. Repeated iterations of this operation result in a converged set of the connection weights, yielding a model that is trained to identify and learn patterns between sets of input data and corresponding sets of target outcomes. Once trained, the neural net model can be used predictively to estimate outcomes from fresh input data.

### III. Results

As mentioned earlier, the first modeling stage yields a digital outcome in which the inputs are correlated with binary results for the formation (or not) of pores in any of three directions as shown in FIG. 6.

Out of a total of 1,247 experiments, 601 produced catalytic structures with one set of pores, 179 resulted in structures having two sets of pores, and 38 with three sets of pores. The model correctly correlated the experimental conditions with whether or not potentially useful catalytic material was produced with greater than 85% accuracy. A detailed breakdown of this model's results is shown in Table 1.

TABLE 1
RESULTS OF MODEL 1
correct calls overall

| Pore 1 | Pore 2 | Pore 3 |
|---|---|---|
| 85% | 91% | 98% |
| 1063 | 1129 | 1224 |
| out of | out of | out of |
| 1247 | 1247 | 1247 |

correct positives

| Pore 1 | Pore 2 | Pore 3 |
|---|---|---|
| 87% | 84% | 79% |
| 525 | 151 | 30 |
| out of | out of | out of |
| 601 | 179 | 38 |

false positives

| Pore 1 | Pore 2 | Pore 3 |
|---|---|---|
| 17% | 8% | 1.2% |
| 108 | 90 | 15 |
| out of | out of | out of |
| 646 | 1068 | 1209 |

correct negatives

| Pore 1 | Pore 2 | Pore 3 |
|---|---|---|
| 83% | 92% | 99% |
| 538 | 978 | 1194 |
| out of | out of | out of |
| 646 | 1068 | 1209 |

false negatives

| Pore 1 | Pore 2 | Pore 3 |
|---|---|---|
| 13% | 16% | 21% |
| 76 | 28 | 8 |
| out of | out of | out of |
| 601 | 179 | 38 |

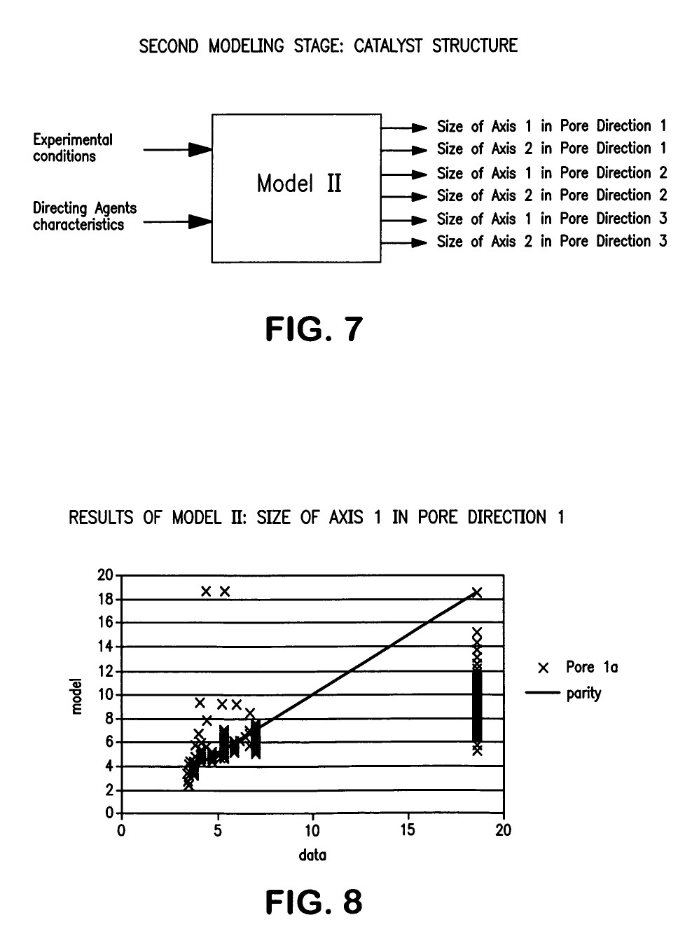

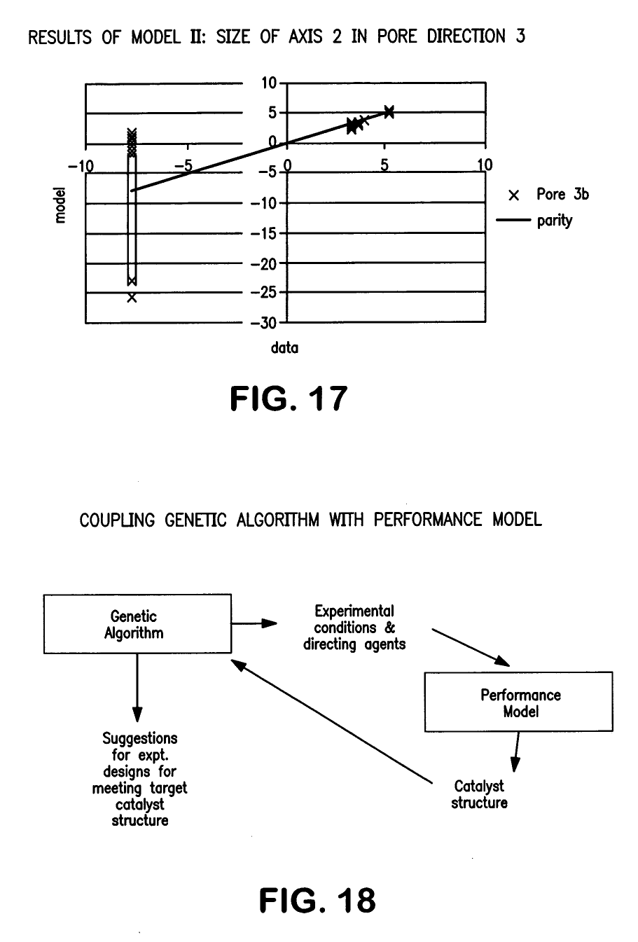

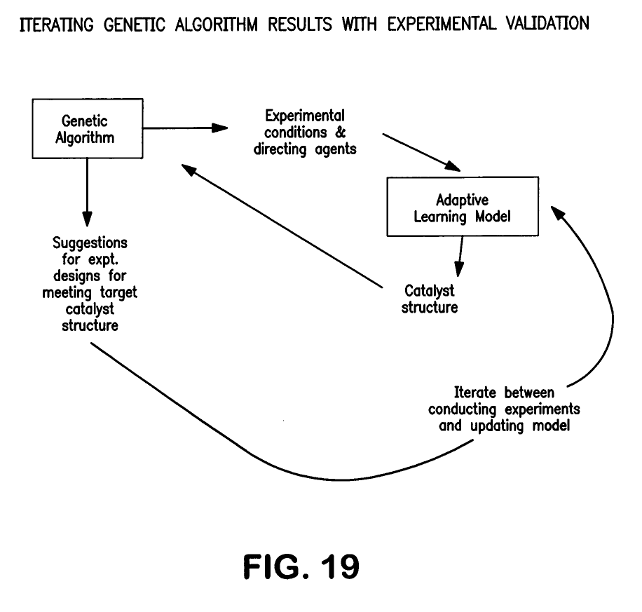

Those data for which any one of the three binary outcomes for pore formation is positive are further processed in a second model quantifying the catalyst structure. The dimensions of the major and minor axes characterizing the pore diameters constitute the quantitative description of the catalyst structure. As mentioned earlier, up to three sets of pores can be attributed to a catalyst. The model for the catalytic structure is shown in FIG. 7. The results of this model are shown in the form of parity plots in FIG. 8 through FIG. 17.

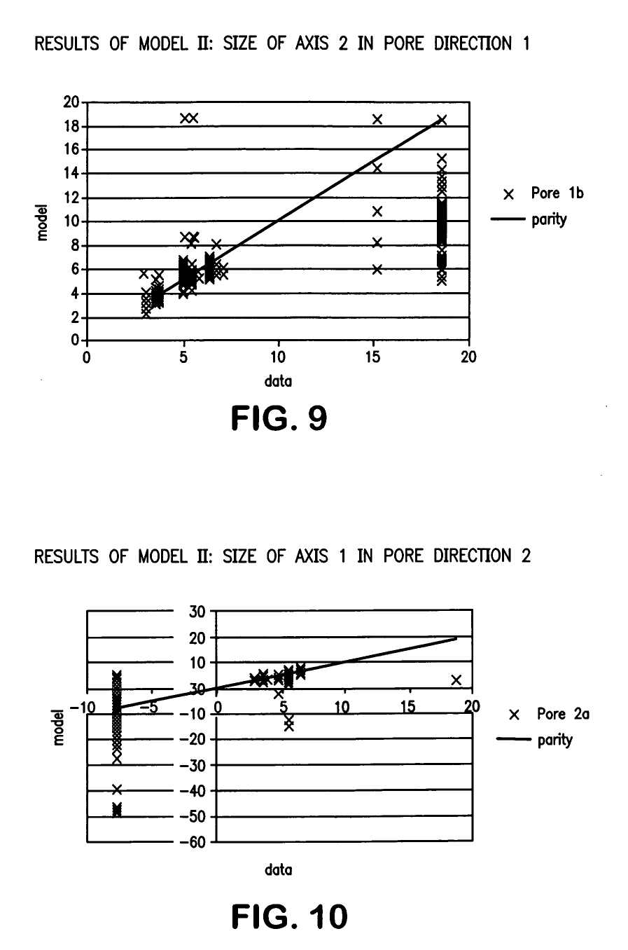

The vertical band of points on the high end of data values corresponds to catalysts with layered structure in FIGS. 8 and 9.

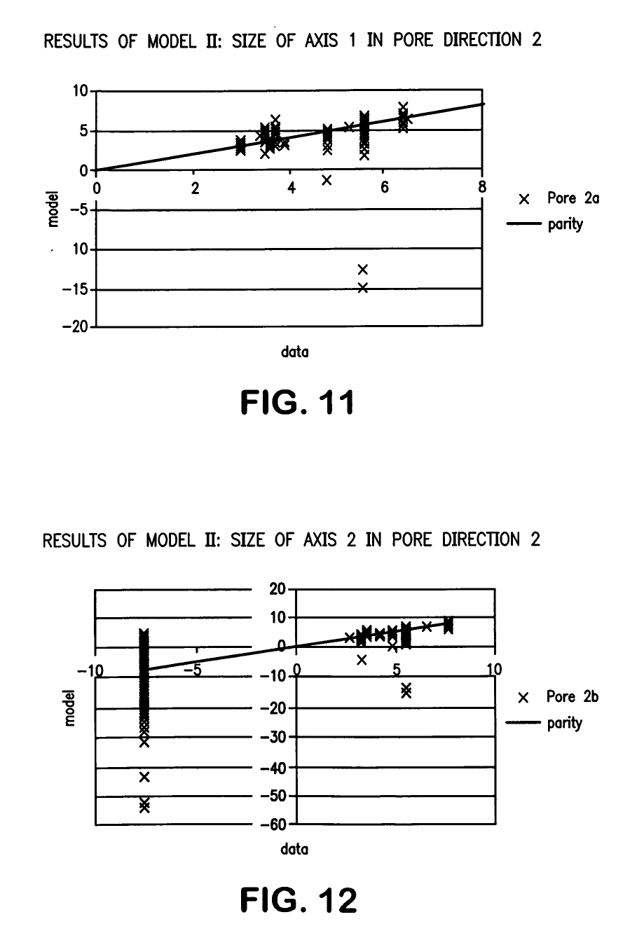

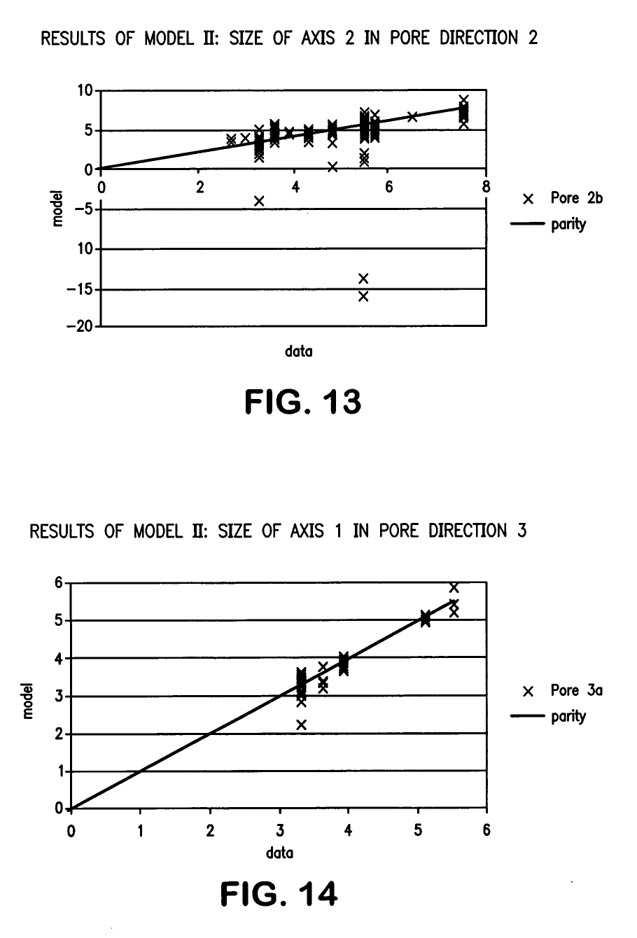

The negative data in FIG. 10 and FIG. 12 correspond to those catalysts that do not have pores in more than one direction. FIG. 11 and FIG. 13 zoom in on the relevant region in FIG. 10 and FIG. 12 respectively.

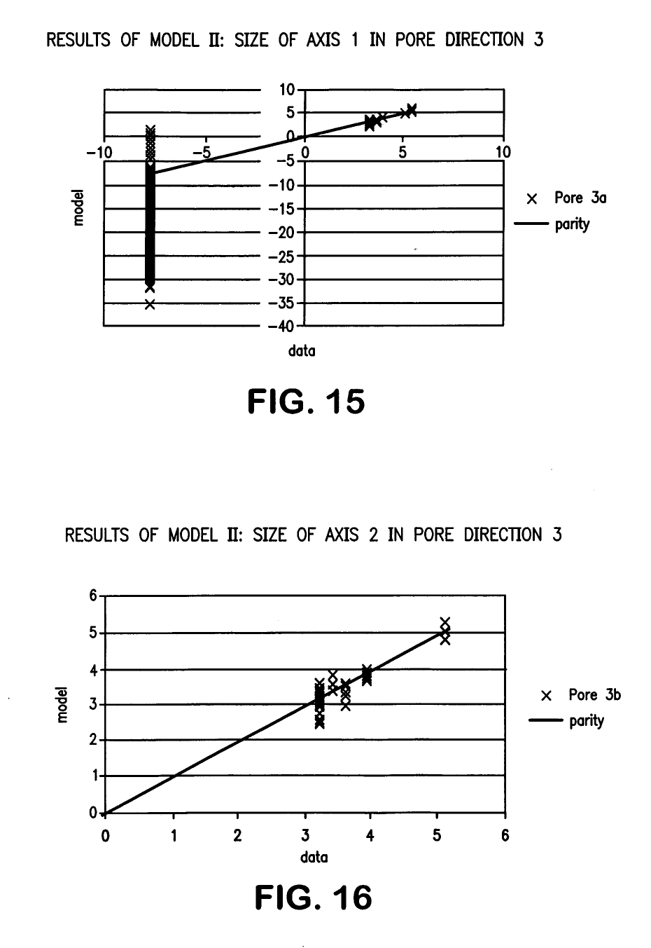

The negative data in FIG. 14 correspond to those catalysts that do not have pores in more than one or two directions. FIG. 15 zooms in on the relevant region in FIG. 14.

C. Coupling Genetic Algorithms with Adaptive Learning Models

Genetic algorithms may be coupled with the adaptive learning models. Genetic algorithms incorporate natural selection principles from evolutionary biology into a stochastic framework, resulting in a very powerful optimizing methodology. Genetic algorithms are especially well suited for optimizing highly non-linear multi-dimensional phenomena which pose considerable difficulty to conventional methods, particularly if the objective functions to be optimized are discontinuous. One of the main advantages of using genetic algorithms is they are not trapped into local optima. The central idea behind coupling them with adaptive learning performance models that capture experimental experience is to enhance catalyst discovery by searching the experimental space for potential regions of high yielding results.

What is claimed is:

1. A method to determine catalyst structures by correlating experimental conditions and directing agent characteristics to catalyst products.

2. The method of claim 1 wherein said step of correlating is carried out by a performance model.

3. The method of claim 2 wherein said performance model is a neural net.

4. The method of claim 2 wherein step of correlating is performed by a two-stage model.

5. The method of claim 3 wherein said two-stage model includes a first-stage model that correlates experimental conditions and directing agents characteristic to amorphous or quartz structures and catalyst with pores and a second-stage that quantifies the pore structure of the catalyst with pores.

6. The method of claim 5 wherein said first-stage model correlates experimental conditions and directing agent characteristics with binary results for the formation of pores in any of three directions.

7. The method of claim 6 wherein said quantitative description of said pore structure from said second-stage model are pore diameters.

8. The method of claim 1 wherein said experimental conditions include one or more of Al/Si, Zn/Si, Mn/Si, Co/Si, OH⁻/Si, Li/Si, Na/Si, K/Si, reactor temperature, and time at temperature in reactor.

9. The method of claim 8 wherein said directing agent characteristics include one or more of three length measures of size in three dimensions, charge, charge offset, C/N, or amount used (in grams).

10. The method of claim 1 wherein said step of correlating is carried out with an adaptive learning model.

11. The method of claim 10 wherein said adoptive learning model is coupled with a genetic algorithm.

12. The method of claim 11 wherein said genetic algorithm is used to iterate between experiments and updating the adoptive learning model.
